(19) United States
(12) Patent Application Publication
(10) Pub. No.: US 2011/0083799 A1
(43) Pub. Date: Apr. 14, 2011

(54) TIE LAYER BETWEEN A POLYLACTIC ACID FILM AND A POLYETHYLENE ZIPPER OR OTHER COMPONENT

(75) Inventors: Eric PLOURDE, Frankfort, IL (US); Kevin P. OLECHOWSKI, Bourbonnals, IL (US); David J. ANZINI, Middletown, NY (US)

(73) Assignee: ILLINOIS TOOL WORKS INC., Glenview, IL (US)

(21) Appl. No.: 12/851,673

(22) Filed: Aug. 6, 2010

Related U.S. Application Data
(60) Provisional application No. 61/249,868, filed on Oct. 8, 2009.

(51) Int. Cl. B32B 37/24; B32B 37/02

(52) U.S. Cl. 156/244.11; 156/60

(57) ABSTRACT

The disclosure relates to the attachment of polyethylene components, such as, but not limited to, zipper profiles for a reclosable package, to film made from polylactic acid. Functionalized polyolefin is laminated or co-extruded onto the polylactic acid and serves as an intermediate or tie layer for the attachment of the polyethylene components thereto.

This application claims priority under 35 U.S.C. §119(e) of U.S. provisional application Ser. No. 61/249,868 filed Oct. 8, 2009, the disclosure of which is hereby incorporated by reference.

### BACKGROUND OF THE DISCLOSURE

1. Field of the Disclosure

The present disclosure pertains to the attaching of a polyethylene zipper profile, or other polyethylene component, to a polylactic acid (PLA) film or other substrate.

2. Description of the Prior Art

Polylactic acid (PLA) films are relatively new, and have been commercialized within the last several years. However, attempts at attaching a polyethylene zipper profile, or other polyethylene component, to a polylactic acid film, whether by extruding the profile or component onto the film or by heat sealing a pre-made zipper to the film, have been unsuccessful due to the incompatibility between the polyethylene and PLA materials.

The use of conventional polyethylene zipper profiles is desired in order to retain the high desirable reclosability characteristics of polyethylene zipper profiles, without the necessity of developing polylactic acid zipper profiles.

### OBJECTS AND SUMMARY OF THE DISCLOSURE

It is therefore an object of the present disclosure to provide a method for the attaching a polyethylene zipper profile, or other polyethylene component, to a polylactic acid film.

This and other objects are obtained by providing extruding a functionalized polyolefin onto the polylactic acid film or substrate and then extruding the polyethylene zipper onto the functionalized polyolefin layer.

### BRIEF DESCRIPTION OF THE DRAWINGS

Further objects and advantages of the invention will become apparent from the following description and from the accompanying drawing, wherein:

FIG. 1 is a cross-sectional view of a polylactic acid film with extruded functionalized polyolefin on areas or portions thereof, with the polyethylene zipper profiles attached to the areas of extruded functionalized polyolefin.

FIG. 2 is a cross-sectional view further showing a tear bead formed from extruded functionalized polyolefin.

### DETAILED DESCRIPTION OF THE PREFERRED EMBODIMENTS

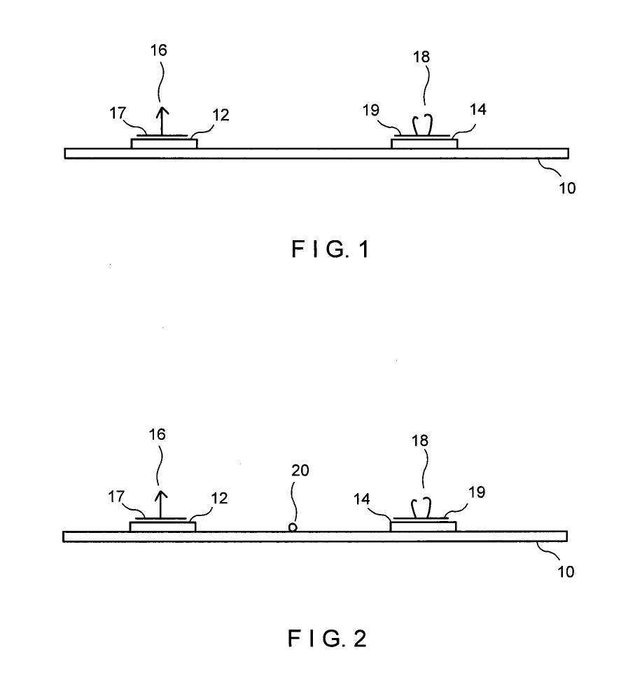

Referring now to the drawings in detail wherein like numerals indicate like elements throughout the several views, one sees that FIG. 1 is a cross-sectional view of film 10 with a polylactic acid surface or layer. The film 10 may be a homogenous or mono layer or film of polylactic acid or made by co-extruded or laminated with a polylactic surface on top of a substrate (not shown) of other materials. A layer of polyolefin, preferably functionalized polyolefin, has been co-extruded or laminated onto at least areas 12, 14. It is envisioned that within the scope of this disclosure could include a functionalized polyolefin layer covering either all or portions of the polylactic acid surface.

Complementary, male and female zipper profiles 16, 18, with respective bases 17, 19, are formed from polyethylene, typically low density polyethylene (known in the art as “LDPE”) but may likewise be formed from materials including, but not limited to, high density polyethylene, medium density polyethylene, linear low density polyethylene, metallocene linear low density polyethylene (all of which are terms known in the art), or blends thereof, or even polypropylene. The male and female zipper profiles 16, 18 are extruded (typically subsequent to any extruding of the areas 12, 14 of functionalized polyolefin) or otherwise joined to areas 12, 14 of functionalized polyolefin. The areas 12, 14 of functionalized polyolefin serve as intermediate or tie layers thereby allowing the attachment of the bases 17, 19 of polyethylene zipper profiles 16, 18 to the structure of FIG. 1. Alternatively, the functionalized polyefin could be applied (such as, but not limited to, by co-extrusion or lamination) to the polyethylene zipper bases 17, 19, and then the zipper bases 17, 19 could be heat sealed to the polylactic acid surface. This heat sealing forms areas 12, 14 of functionalized polyolefin between the polylactic acid surface 10 and the polyethylene zipper bases 17, 19.

In general, functionalized polyolefins may be defined as polyolefins which have been functionalized to include at least one epoxy, anhydride or acid functional group, this functional group being introduced by grafting or by copolymerization. Examples of functionalized polyolefins which have been found to be particularly advantageous for this disclosure are Admer SE800 from Mitsui or Bynel products from DuPont.

Further, as shown in FIG. 2, a functionalized polyolefin tear bead 20 could be extruded onto, or attached, directly to the polylactic acid film 10 because the polyethylene of the tear bead 20 will not adhere directly to the polylactic acid film 10.

In these examples, the film 10 is typically subsequently folded so as to align male and female zipper profiles 16, 18, and to allow the interlocking thereof. However, in other applications, male and female zipper profiles 16, 18 may be attached to separate films and brought together as is required for the specific application.

Thus the several aforementioned objects and advantages are most effectively attained. Although preferred embodiments of the invention have been disclosed and described in detail herein, it should be understood that this invention is in no sense limited thereby and its scope is to be determined by that of the appended claims.

What is claimed is:

1. A process, including the steps of,
providing a surface of polylactic acid material;
providing at least a portion of the surface of polylactic acid material with an area of polyolefin;
attaching a polyethylene component to the area of polyolefin.

2. The process of claim 1 wherein the polyolefin is functionalized polyolefin.

3. The process of claim 2 wherein the surface of polylactic acid material is a homogenous film of polylactic acid material.

4. The process of claim 2 wherein the surface of polylactic acid material is extruded.

5. The process of claim 2 wherein the area of polyolefin is co-extruded onto the surface of polylactic acid.

6. The process of claim 2 wherein the area of polyolefin is laminated onto the surface of polylactic acid.

7. The process of claim 2 wherein the step of attaching the polyethylene component includes the step of extruding the polyethylene component onto the area of polyolefin.

8. The process of claim 2 wherein the area of polyolefin covers a first portion of the surface of polylactic acid and a second portion of the surface of polylactic acid is free of the area of polyolefin.

9. The process of claim 2 wherein the polyethylene component is made from material selected from the group consisting of low density polyethylene, high density polyethylene, medium density polyethylene, linear low density polyethylene, metallocene linear low density polyethylene, and blends thereof.

10. A process, including the steps of,
providing a surface of polylactic acid material;
providing at least a portion of the surface of polylactic acid material with a first area and a second area of polyolefin;
attaching a first polyethylene zipper component to the first area of polyolefin and a second polyethylene zipper component to the second area of polyolefin.

11. The process of claim 10 wherein the polyolefin is functionalized polyolefin.

12. The process of claim 10 wherein the surface of polylactic acid material is a homogenous film of polylactic acid material.

13. The process of claim 10 wherein the surface of polylactic acid material is extruded.

14. The process of claim 10 wherein the first and second areas of polyolefin are co-extruded onto the surface of polylactic acid.

15. The process of claim 10 wherein the first and second areas of polyolefin are laminated onto the surface of polylactic acid.

16. The process of claim 10 wherein the step of attaching includes the step of extruding the first and second polyethylene zipper components onto the respective first and second areas of polyolefin.

17. The process of claim 10 further including the step of extruding a functionalized polyolefin tear bead onto the surface of polylactic acid material.

18. The process of claim 10 wherein the first and second polyethylene zipper components are made from material selected from the group consisting of low density polyethylene, high density polyethylene, medium density polyethylene, linear low density polyethylene, metallocene linear low density polyethylene, and blends thereof.

19. A process, including the steps of,
providing a length of zipper material;
applying polyolefin to a portion of the length of zipper material;
providing a surface of polylactic acid material;
attaching the portion of the length of zipper material to which the polyolefin was applied to the surface of polylactic material.

20. The process of claim 19 wherein the polyolefin is functionalized polyolefin.
